(19) United States
(12) Patent Application Publication
(10) Pub. No.: US 2025/0363917 A1
(43) Pub. Date: Nov. 27, 2025

(54) Flag Assembly

(71) Applicant: Fast-Flag LLC, Naples, FL (US)

(72) Inventor: Tunc Hamami, Naples, FL (US)

(21) Appl. No.: 18/671,125

(22) Filed: May 22, 2024

(51) Int. Cl. G09F 17/00

(52) U.S. Cl. CPC G09F 17/00; G09F 2017/0008

(57) ABSTRACT

A mast has proximal and distal ends, a first support projecting away from the mast in a first support projection direction at a first support location at or adjacent to the distal end, and a second support projecting away from the mast at a second support location in a second support projection direction intermediate of the distal and proximal ends. The second support location is closer to the proximal end than the first support location. A flag element is disposed between the first and second supports. The first and second support projection directions are parallel to each other. The mast is mountable to an object at or adjacent to the proximal end such that the mast projects away from the object at an angle toward the first and second support projection directions. The mast pivots along a pivot axis parallel to the first and second support projection directions.

### BACKGROUND AND SUMMARY

The disclosure relates to a device for displaying a flag element and more particularly to a static flag element that has the appearance of a flag completely unfurled and fully extended for display.

Applicant's prior patents U.S. Pat. Nos. 10,783,812 and 10,783,813 disclose a flag display device that fully displays a flag regardless of the presence of wind. The prior flag device is configured to be mountable to a surface, such as a surface of a boat. A mast extends upward from the surface, and horizontal support arms extend perpendicularly from the mast. The top horizontal support arm and the bottom horizontal support arm are parallel to each other and are spaced apart to support a flag element therebetween. The flag element may have a flag design cutout so that negative spaces or cutout portions form the pattern comprising the flag.

Applicant has continued its development, and to improve the visual appearance of the flag element, applicant has developed a mast which is acutely angled to the support in the direction of the flag to provide the further enhanced effect of a flag completely unfurled and fully extended for display. Additionally, applicant has developed a pivoting mast which allows the user to temporarily lower the mast, as may be needed, for instance, when overhead clearance is limited, as may be the case when passing under a bridge. Given the acute angle of the mast relative to the support surface, the axis of pivoting is parallel to a plane defined by the flag element. Additionally, or in the alternative, the mast may depend downward from the support surface at an acute angle relative to the support surface to provide the further effect of a flag completely unfurled and fully extended for display. Other benefits and advantages of the flag assembly are disclosed herein.

### BRIEF DESCRIPTION OF THE DRAWINGS

FIG. 1 is a side view of an exemplary flag assembly;

FIG. 2 is a top view of the flag assembly of FIG. 1 with elements of the mast and first and second supports shown in broken lines for additional detail;

FIG. 3 is a rear view of the flag assembly of FIG. 1 showing a pivoting mast;

FIG. 4 is a top view of a first portion of the hinge assembly comprising the pivoting mast;

FIG. 5 is a top view of a second portion of the hinge assembly comprising the pivoting mast;

FIG. 6 is a side view of a flag element comprising an applique on a rigid panel;

FIG. 7 is a side view of another embodiment of the flag assembly;

FIG. 8 is a side view of another embodiment of the flag assembly;

FIG. 9 is a side view of another embodiment of the flag assembly;

FIG. 10 is a side view of another embodiment of the flag assembly;

FIG. 11 is a side view of another embodiment of the flag assembly showing additional mounting options provided via a split ring clamp;

FIG. 12 is a side view of an embodiment of the flag assembly of FIG. 11;

FIG. 13 is a bottom view of the flag assembly of FIG. 12;

FIG. 14 is a side view of another embodiment of the flag assembly showing additional mounting options provided via a mounting plate;

FIG. 15 is a side view of an embodiment of the flag assembly of FIG. 14;

FIG. 16 is a bottom view of the flag assembly of FIG. 14 and FIG. 15;

FIG. 17 is a side view of another embodiment of the flag assembly;

FIG. 18 is a front view thereof;

FIG. 19 is a rear view thereof;

FIG. 20 is a top view thereof;

FIG. 21 is a bottom view thereof;

FIG. 22 is another side view thereof;

FIG. 23 is a perspective view thereof; and

FIG. 24 is an alternate perspective view thereof.

### DETAILED DESCRIPTION

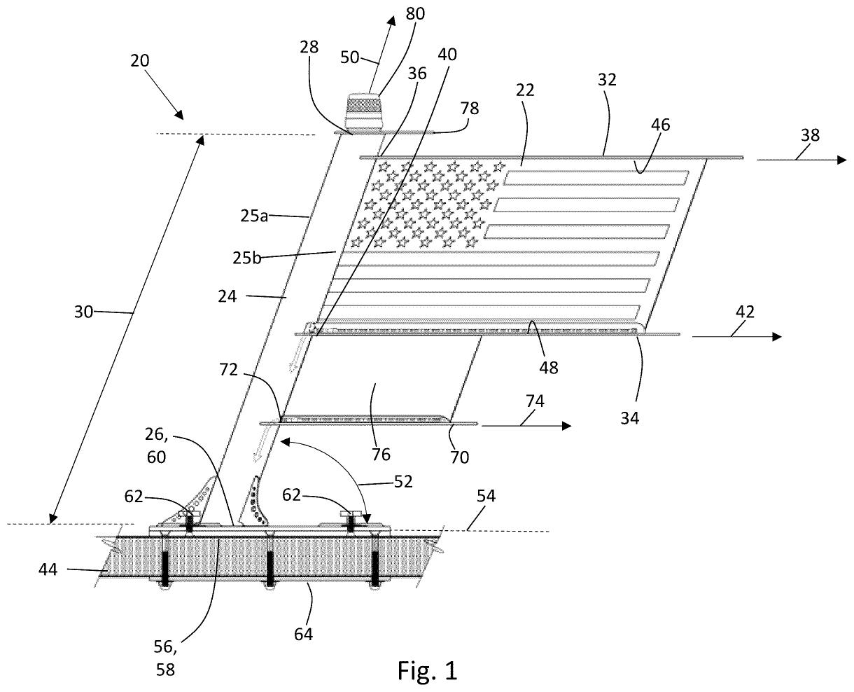

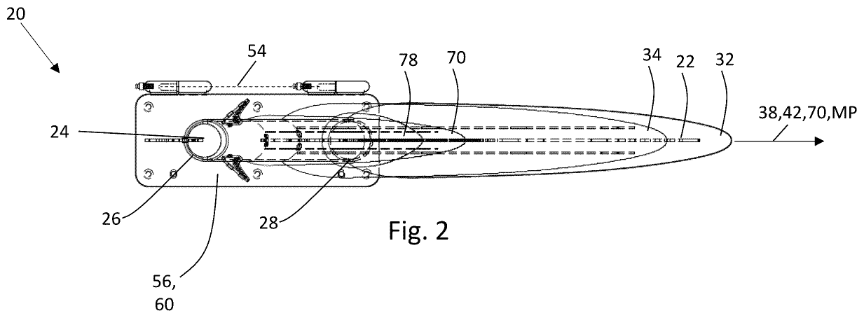

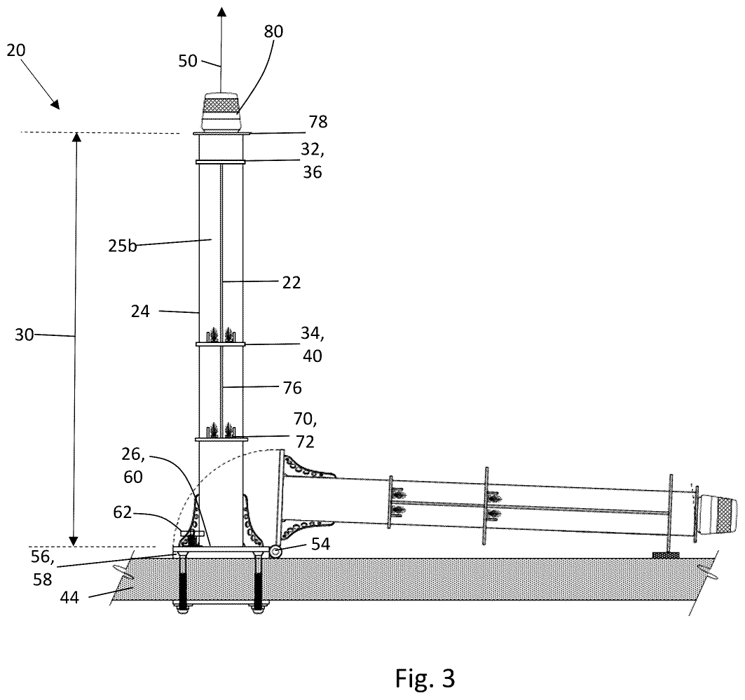

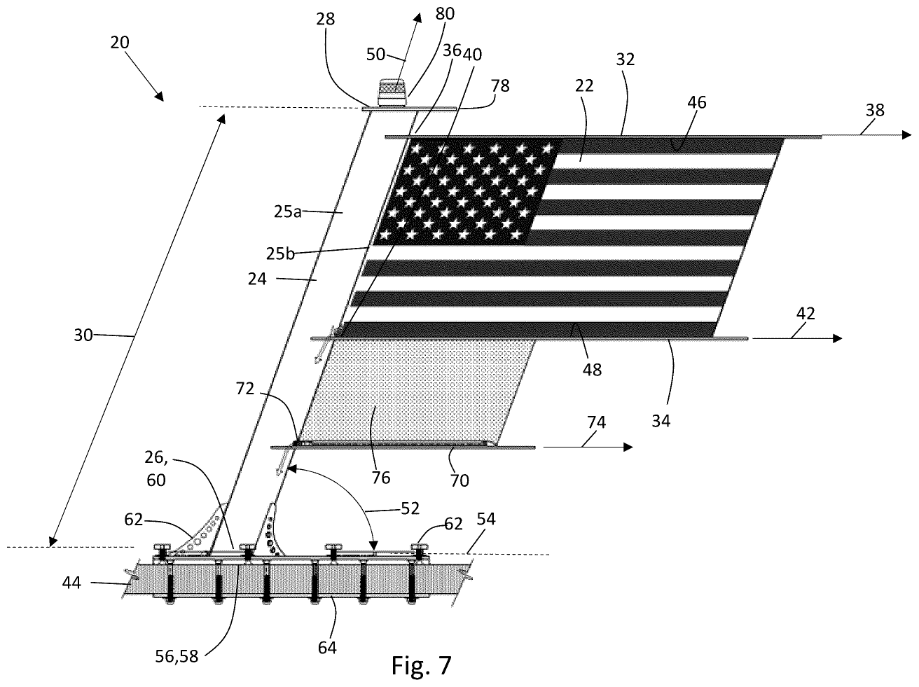

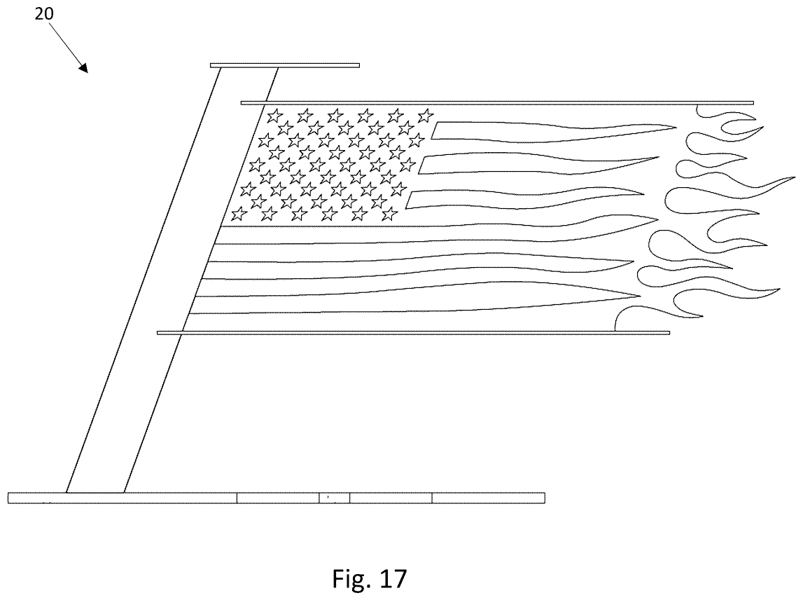

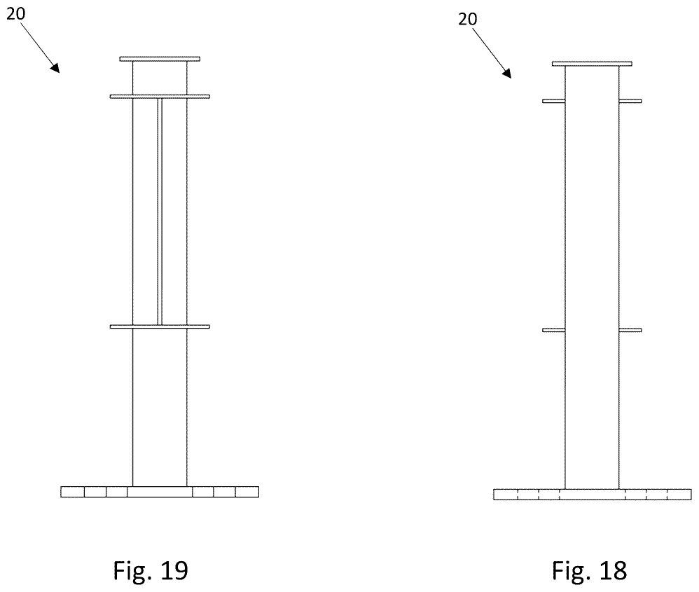

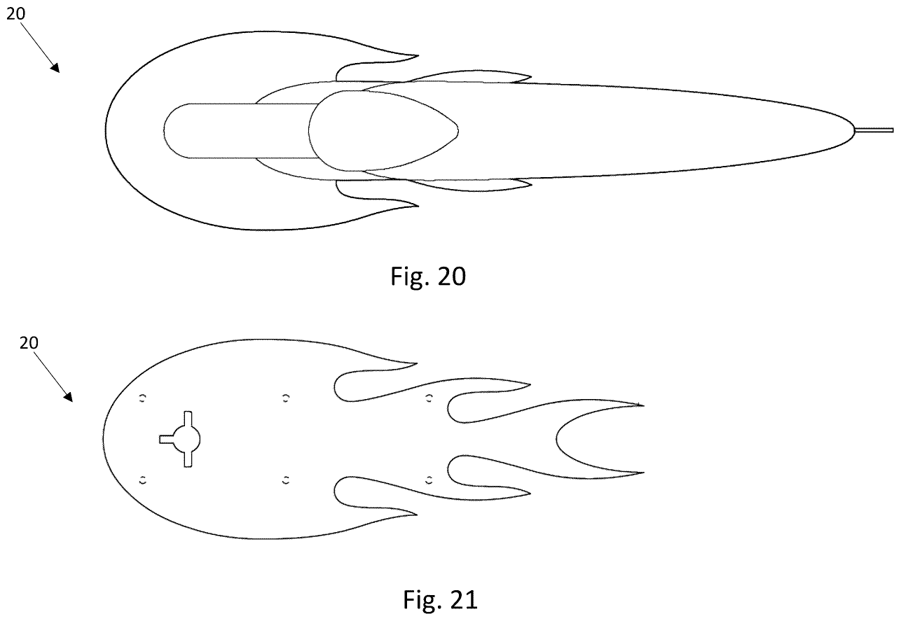

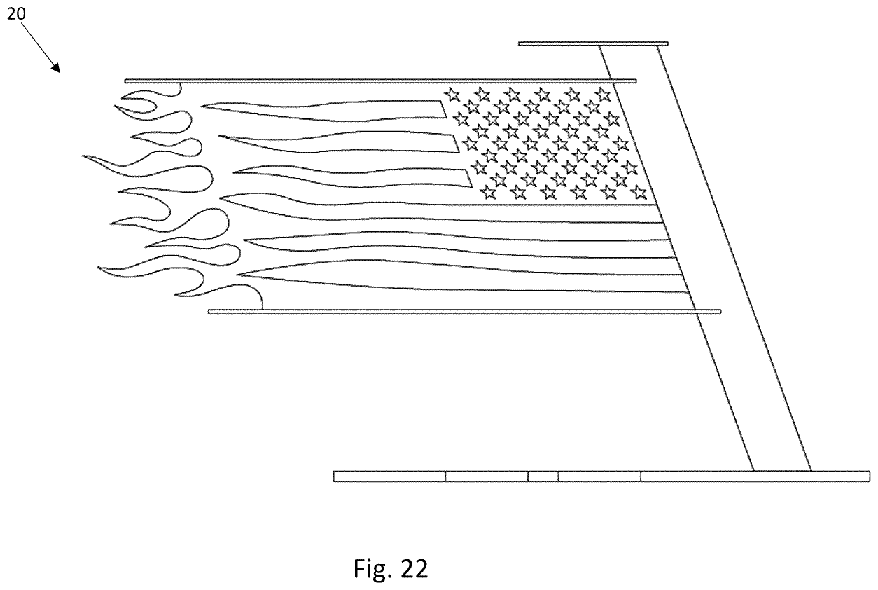

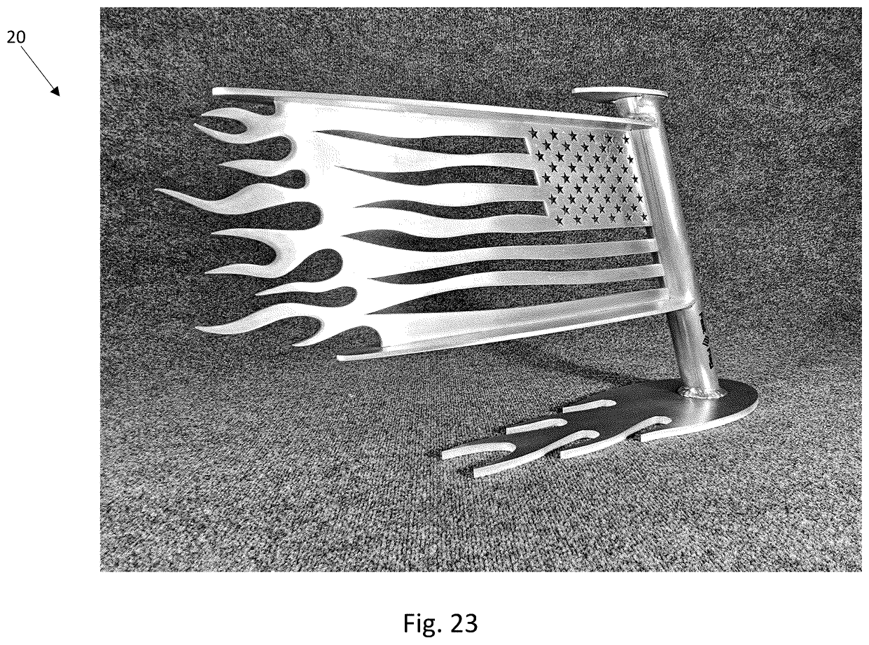

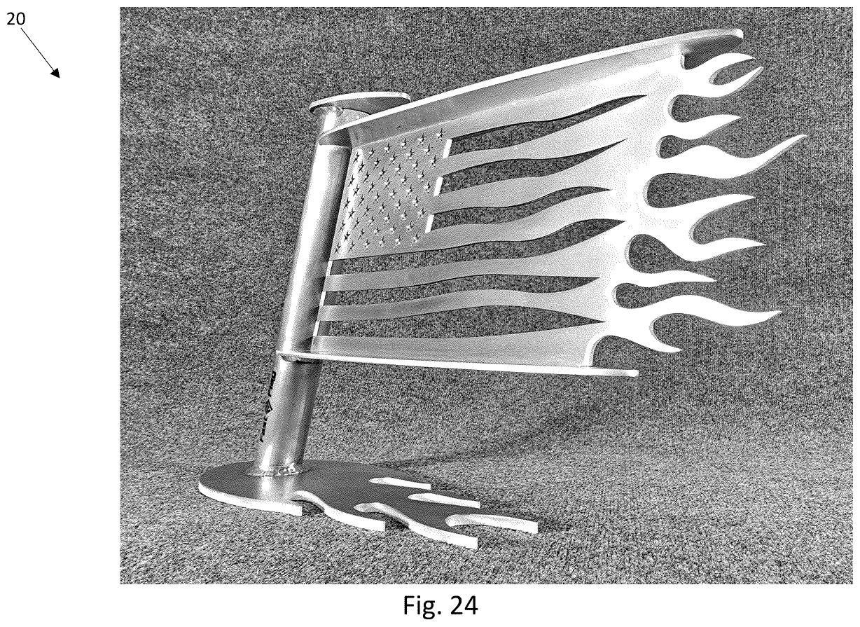

With reference to FIGS. 1, 7-10, 17 and 22, a side view of a flag assembly 20 is shown. By way of example, the flag assembly 20 supports a rigid and an angled rectangularly shaped (e.g., rhomboid shaped) flag element 22. In each of the embodiments of the flag assembly shown in FIGS. 1, 7-10, and 17-24, the flag assembly 20 has a mast 24. The mast 24 may have a leading surface 25a that is directed toward the normal direction of travel and a trailing surface 25b that is generally opposite of the leading surface. The mast 24 has a proximal end 26 and a distal end 28 with a length 30 extending between the proximal end and the distal end. The mast 24 includes a first support 32 and a second support 34. The first support 32 projects away from the mast at a first location 36 in a first support projection direction 38 at or adjacent the distal end 28 of the mast, and the second support 34 projects away from the mast at a second support location 40 in a second support projection direction 42 intermediate of the distal end and the proximal end of the mast. The first support projection direction 38 and the second support projection direction 42 may extend in parallel planes, which may be horizontal parallel planes and/or vertical parallel planes when the mast is mounted to an object. In one aspect, the first support projection direction 38 and the second support projection direction 42 may define a vertical plane when the mast 24 is mounted to another object 44. The vertical plane may be a medial plane of the flag assembly. The first and second supports 32,34 may extend around a portion of the mast 24, and the first and second support projection directions 38,42 may aligned radially with a centroid of the mast 24. The mast 24 may have a cylindrical or tear drop shaped cross-section. The first and second supports 32,34 may have a tear drop shape in plan view.

The flag element 22 is disposed between the first and second supports 32,34. The flag element may extend in the same plane as the first and second support projection directions 38,42, which may be the medial plane (MP) of the mast. The flag element 22 may have a conventional top 46 and a conventional bottom 48. The first support 32 that projects from the mast at the first support location 36 at or adjacent the distal end 28 of the mast 24 may be aligned with the conventional top 46 of the flag element, and the second support 34 that projects from the mast at the second support location 40, which is intermediate of the distal end and the proximal end, may be aligned with the conventional bottom 48 of the flag element. In this way, the flag element 22 will be right side up when mounted to the object 44.

The mast 24 is adapted and configured to be connected to the object 44 at or adjacent to the proximal end 26 of the mast. The object 44 may be a roof, for instance, of a vehicle, such as an automobile, a boat, a golf cart, a truck, an off-road or all-terrain vehicle. The mast may have a mast projection direction 50 that extends from the proximal end 26 to the distal end 28. The first support 32 and the second support 34 project from the trailing surface 25b of the mast in the respective first and second support projection directions 38,42. When attached to the object 44 with the first and second supports 23,34 and the flag element 22 horizontal, the mast projection direction 50 is angled toward the flag element and forms an included acute angle 52 between the trailing surface of the mast and a horizontal reference plane extending through the proximal end 26. In other words, the mast projection direction 50 is angled in the direction toward the first and second support projection directions 38,42. Or, in other words, the mast projection direction 50 is angled toward the flag element 22. The included acute angle 52 may be between about 60 and about 80 degrees. More preferably, the included acute angle 52 is about 70 degrees. When the flag assembly is mounted to the object 44 with the mast leading surface aligned toward the direction of travel of the object, the included acute angle 52 gives the physical appearance that the object is moving under high speed and the mast is being swept back, regardless of the actual speed of the object.

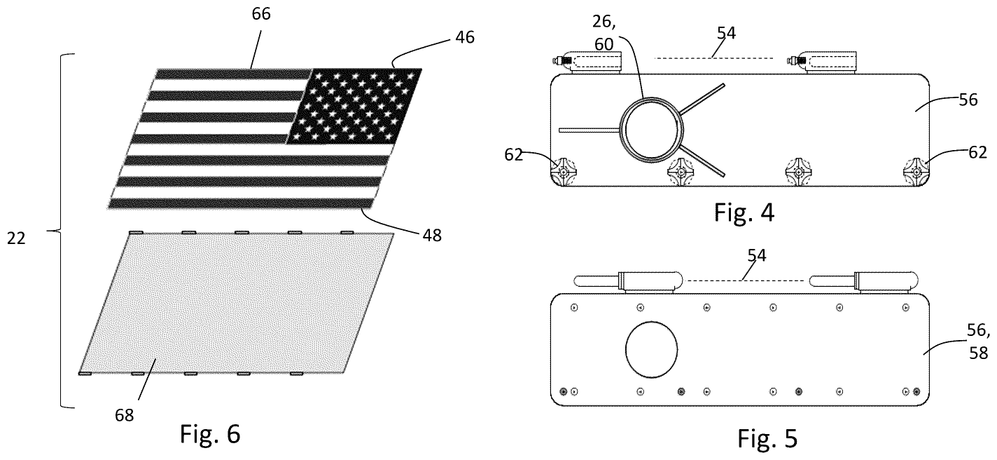

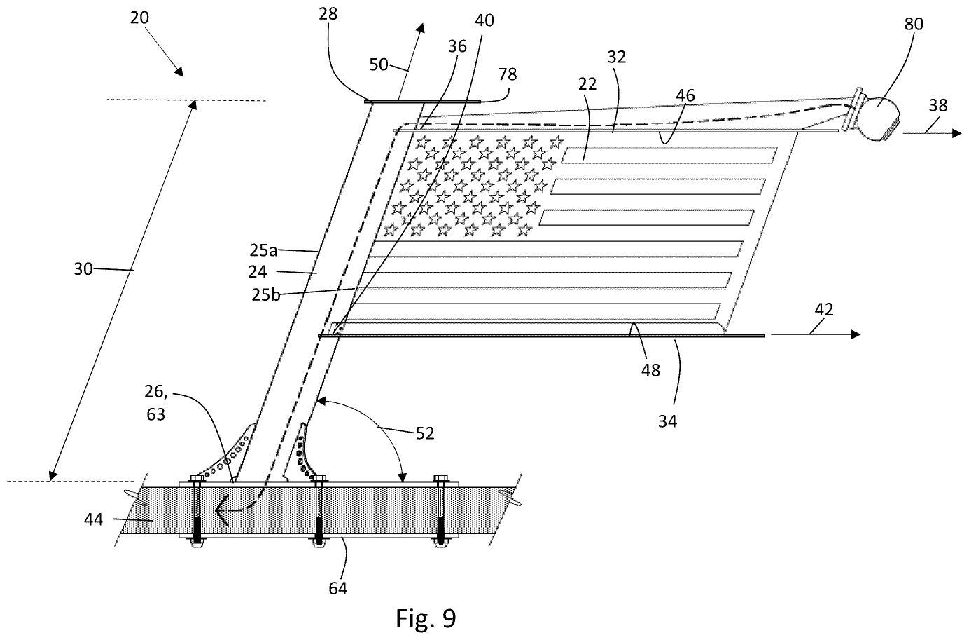

In another aspect, the mast 24 may be pivotable relative to the object 44 to which the mast is configured for connection along a pivot axis 54 that is parallel to the first support projection direction 38 and the second support projection direction 42. In one example, for instance, as shown in FIGS. 4-5, the proximal end 26 of the mast comprises a hinge assembly 56. The hinge assembly 56 may include a first portion 58 that is adapted and configured for connection to the object 44, and a second portion 60 that is hingedly connected to the first portion 58. The mast 24 may project from the second portion 60 with the proximal end 26 of the mast being operatively connected with the second portion of the hinge assembly. The proximal end 26 of the mast 24 may be integral with second portion 60 of the hinge assembly 56 and form the included acute angle 52 toward the flag element. Gussets may be provided to reinforce the operative connection between the second portion of the hinge assembly and the proximal end of the mast. The hinge assembly 56 may comprise an aluminum bullet hinge with zirc grease fittings. The hinge assembly 56 may be pivotable and releasably connectable at the pivot axis 54 (e.g., via the bullet hinge) to allow the mast 24 to be lowered or removed as desired. The pivot axis 54 may be provided along one edge of the hinge assembly 56 and mechanical fasteners 62 may be provided opposite the pivot axis 54 across the hinge assembly to releasably secure the first and second portions 58,68 of the hinge assembly together and to allow a releasable connection to allow the mast to be lowered or raised into position as desired. A bumper may be provided adjacent the distal end of the mast to prevent fretting wear on the object when the mast is lowered. In the alternative to the hinge assembly 56, a mounting plate 63 (by way of example see FIG. 9) may be provided at the proximal end of the mast, for instance, to allow mounting of the mast to a generally flat structure. In a further alternative, a split ring clamp (e.g., a Roswell style clamp) may be provided at the proximal end of the mast, for instance, to allow mounting of the mast to a generally round structure such as tubular railings. In connecting the object with the hinge assembly or mounting plate, a backer plate 64 may be provided on the underside of the surface of the object to provide additional structural integrity for mounting the mast to the object. The backer plate 64 may be connected to the first portion 58 of the hinge assembly 56 or the mounting plate, as the case may be, with the structure of the object sandwiched therebetween.

The flag element 22 may be supported between the first and second supports 32,34 with a bottom of the first support engaging a top edge of the flag element and a top of the second support engaging a bottom edge of the flag element. In one aspect, the flag element 22 may be interchangeable and removably connectable with the first and second supports 32,34 to allow a user to select between multiple flags. For instance, as shown by example in FIG. 6, the flag element 22 may comprise an applique 66 on a rigid panel 68, or may comprise a magnetic overlay on a rigid panel. The flag element shown in FIG. 6 is actually used in connection with the flag element of FIG. 15, but illustrates the principle of an applique applied to a rigid panel. In another aspect, the flag element 22 may be integral or monolithic with the supports and/or mast. For instance, the flag element may be a rigid panel with cut-outs defining a pattern for the flag element. As illustrated in FIGS. 1, 12, and 17-24, the flag element comprises an American flag with the stars and stripes cut (e.g., laser cut) from a solid panel to define the pattern for the flag.

In another embodiment, the mast 24 includes a third support 70 projecting from the mast at a third support location 72. The third support location 72 may be intermediate of the proximal end 26 of the mast and the second support location 72. The third support 70 may project away from the mast in a third support projection direction 74. The third support projection direction 74 may be parallel to the first support projection direction 38 and the second support projection direction 42. The third support projection direction 74, and one or both of the first support projection direction 38 and/or the second support projection direction 42 may extend in parallel planes, which may be horizontal parallel planes and/or vertical parallel planes when the mast is mounted to the object 44. In one aspect, the third support projection direction 74, and one or both of the first support projection direction 38 and the second support projection direction 42 may define a vertical plane when the mast is mounted to another object. The vertical plane may be a medial plane of the flag assembly. The third support 72 may extend around a portion of the mast 24, and the third support projection direction may be aligned radially with a centroid of the mast. The third support 24 may have a tear drop shape in plan view.

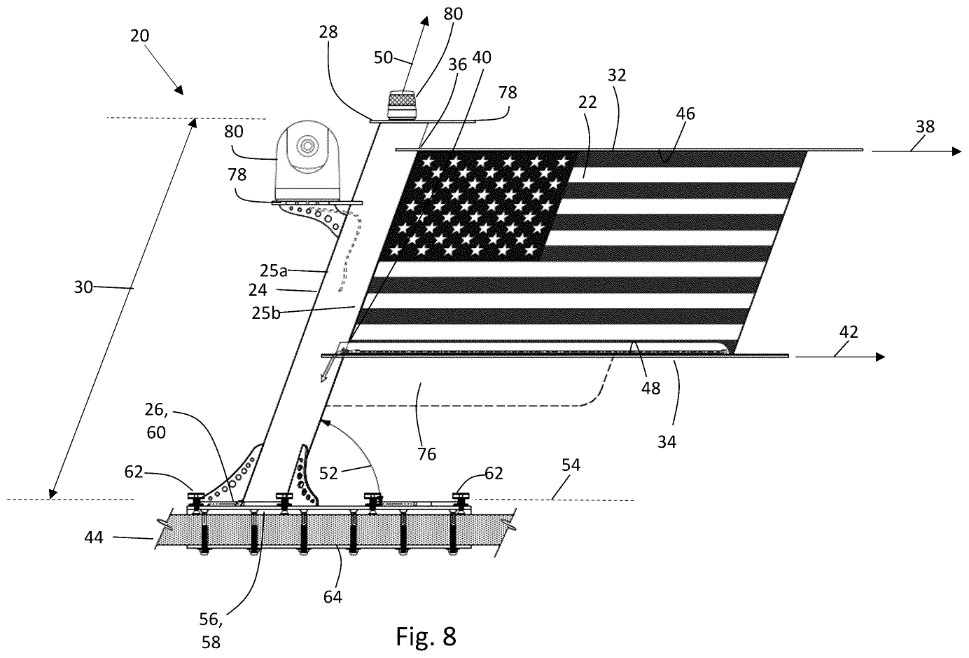

A further panel 76 may be disposed between the second and third supports 36,70. The further panel 76 may be supported between the second and the third supports 36,70 with a bottom of the second support engaging a top edge of the further panel and a top of the third support engaging a bottom edge of the further panel. In one aspect, the further panel 76 may be interchangeable to allow a user to select between multiple panels. For instance, the further panel may comprise an applique on a rigid panel, or may comprise a magnetic overlay on a rigid panel. The further panel 76 may comprise a flag, for instance, a state flag, or may comprise a nameplate or other display. In another aspect, the further panel 76 is integral or monolithic with the supports and/or mast. For instance, the further panel 76 may be a rigid panel with cut-outs defining a pattern for the further panel. Instead of providing a third support, the further panel may depend from the bottom of the second support 34 as shown in FIG. 8.

The mast 24 may be provided with one or more mounting plates 78 at and/or adjacent to its distal end. The mounting plate 78 may form a cap of the mast 24 or function as a platform for mounting one or more accessories 80 to or adjacent the distal end 28 of the mast, for instance, a light, a mast light, a camera, and/or antenna.

The supports 32,34,70 may be provided with attachment mechanisms to allow the flag element and/or the further panel to be exchanged. The attachment mechanisms may be a U-shaped channel on the bottom of the first support that engages the top edge of the flag element and a U-shaped channel on the top of the second support that engages the bottom edge of the flag element. A retainer, such as a pin, bolt, or screw, may be used to lock the flag element and/or a further panel within the respective U-shaped channels.

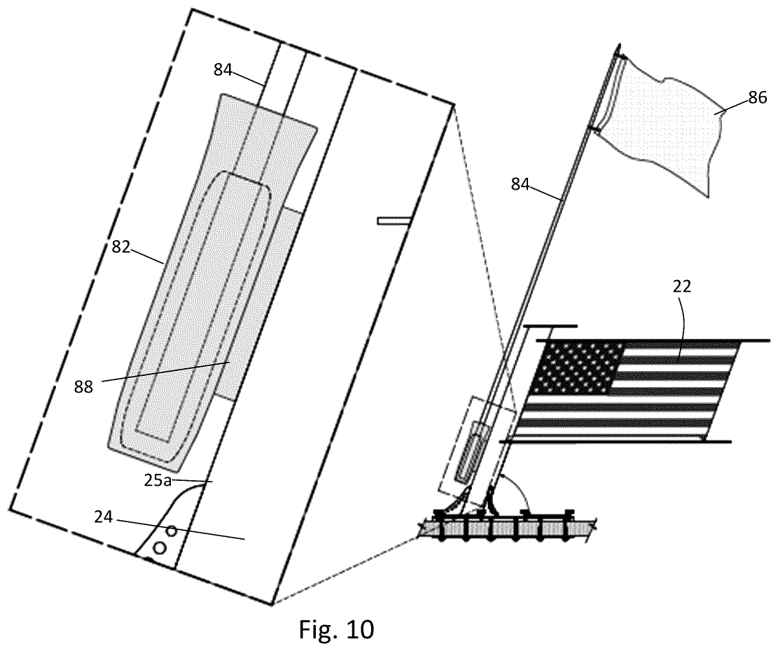

With reference to FIG. 10, the flag assembly 20 may include a sleeve 82 arranged along the length of the mast. For instance, the sleeve may be arranged on the leading side 25a of the mast, which may be opposite of the first support projection direction and/or the second support projection direction. The sleeve 82 may have an interior that is adapted and configured to receive a further mast 84 of a further flag 86. The further mast 84 may comprise a fiberglass “whip” style mast. The further flag 86 may be a temporary flag, for instance, a quarantine flag, a dive flag, or host nation flag. The sleeve 82 may be mounted on the mast 24 with a spacer.

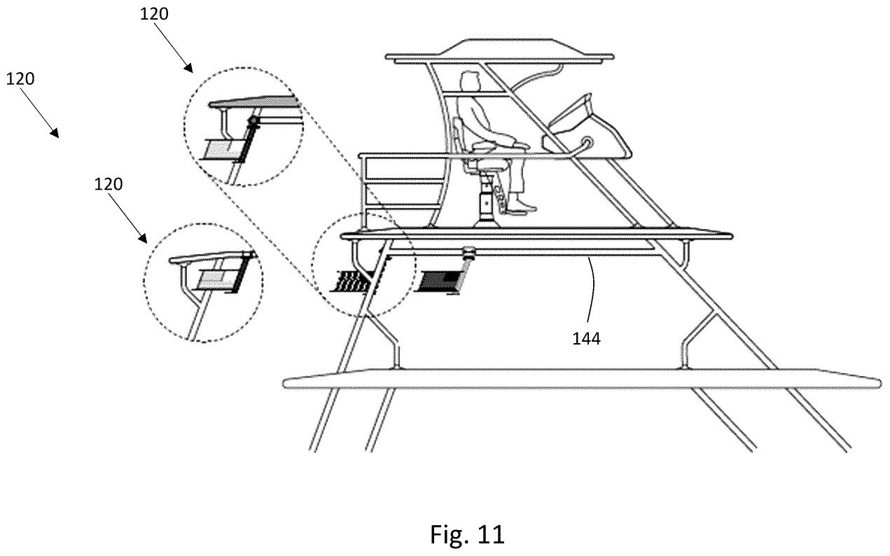

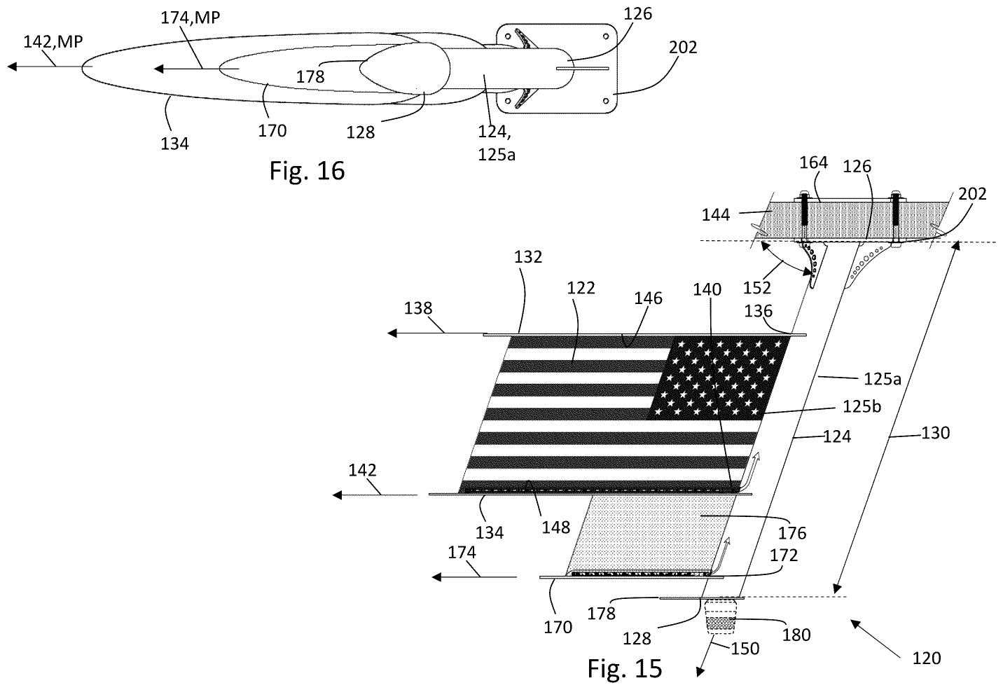

With reference to FIGS. 11-16, the flag assembly 120 may have a mast 124 that is configured to depend from the object 144 to which the mast is attached. The mast 124 may have the leading surface 125a and the trailing surface 125b. Accordingly, the first and second supports 132,134 may be reconfigured with the first support projecting from the mast in the first support projection 138 direction at the first support location 136 which is closer to the proximal end 126 of the mast, and with the second support 134 projecting from the mast in the second support projection direction 142 at the second support location 140 which is closer to the distal end 128 of the mast. The flag element 122 may be disposed between the first and second supports 132,134 with the conventional top 146 of the flag element being adjacent the first support and the conventional bottom 148 of the flag element being adjacent the second support. As described previously, the mast 124 is adapted and configured to be mounted to an object 144 adjacent to the proximal end 126 of the mast in a manner such that the mast projects in the mast projection direction 150 away from the object 144 at the included acute angle toward the first support projection direction 138 and the second support projection direction 142. The flag element 122 may be as previously described.

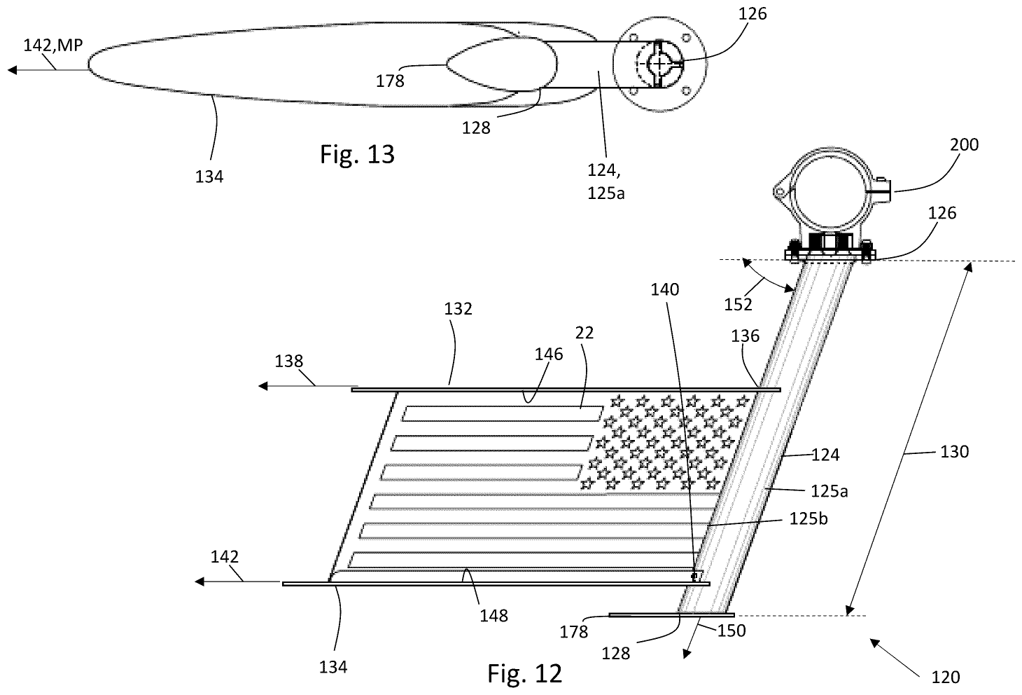

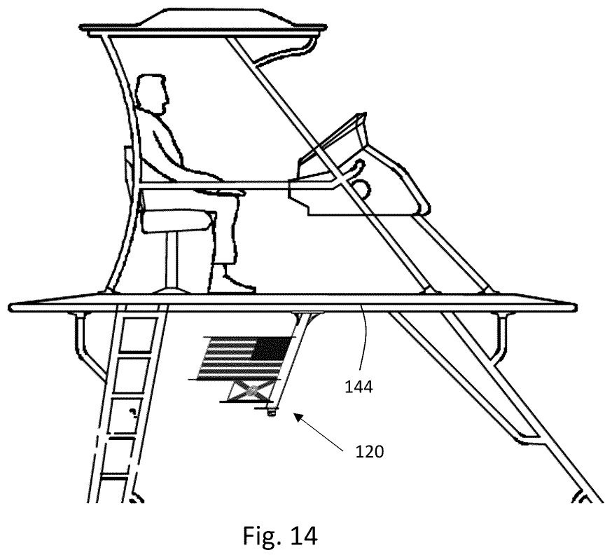

In one aspect, for instance, as shown in FIGS. 11-12, a split ring clamp 200 (e.g., a Roswell style clamp) may be provided at the proximal end of the mast, for instance, to allow mounting of the mast to a generally round structure such as tubular railings. In another aspect, for instance, as shown in FIGS. 14-16, a mounting plate 202 may be provided at the proximal end of the mast, for instance, to allow mounting of the mast to a generally flat structure. In connecting the object 144 with the mounting plate 202, a backer plate 164 may be provided on the top surface of the object to provide additional structural integrity for mounting the mast to the object. Gussets may be provided to reinforce the operative connection between the mounting plate 202 and the proximal end of the mast.

As discussed previously, the mast projection direction 150 forms the included acute angle 152 with the proximal end 126 of the mast 124. Thus, the mast projection direction 150 is angled toward the first and second support projection directions 138, 142, that is, the mast projection direction is angled toward the flag element 122. The included acute angle 152 may be between about 60 and about 80 degrees. More preferably, the included acute angle is about 70 degrees. In the configurations shown in FIGS. 11-16, when the flag assembly 120 is mounted to the object 144 with the mast leading surface 125a in the direction of travel of the object, the included acute angle 152 gives the physical appearance that the object is moving under high speed and the mast is being swept back, regardless of the actual speed of the object.

In another embodiment, the mast 124 includes a third support 170 projecting from the mast at a third support location 172. The third support location 172 is closer to the distal end 128 of the mast than the second support location 140, and may be at or adjacent the distal end of the mast. The third support 170 may project from the mast in a third support projection direction. The third support projection direction may be parallel to the first support projection direction and the second support projection direction. The third support projection direction 174, and one or both of the first support projection direction 138 and/or the second support projection direction 142 may extend in parallel planes, which may be horizontal parallel planes and/or vertical parallel planes when the mast is mounted to the object 144. In one aspect, the third support projection direction 174, and one or both of the first support projection direction 138 and the second support projection direction 142 may define a vertical plane when the mast is mounted to another object. The vertical plane may be a medial plane (MP) of the flag assembly. The third support 170 may extend around a portion of the mast, and the third support projection direction 174 may be aligned radially with a centroid of the mast. The third support 170 may have a tear drop shape in plan view.

A further panel 176 may be disposed between the second and third supports 134, 170. The further panel 176 may be supported between the second and the third supports 134,170 with a bottom of the second support engaging a top edge of the further panel and a top of the third support engaging a bottom edge of the further panel. In the alternative to providing the third support, the further panel may depend from the bottom of the second support 134. The further panel may be as previously described. An accessory 180 may be provided on the distal end 128 and/or adjacent to the distal end of the mast 124.

It is to be understood that while certain embodiments are illustrated, none is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A flag assembly comprising:
a mast having a proximal end and a distal end with a length extending between the proximal end and the distal end;
a first support, the first support projecting away from the mast in a first support location;
a second support, the second support projecting away from the mast in a second support location, the second support location being intermediate of the distal end and the proximal end of the mast, the second support location being closer to the proximal end of the mast than the first support location, the first support location being closer to the distal end of the mast than the second support location; and
a flag element disposed between the first and second supports;
wherein the first support projects away from the mast in a first support projection direction, the second support projects away from the mast in a second support projection direction, the first support projection direction and the second support projection direction are parallel to each other;
wherein the mast is adapted and configured to be mounted to an object at or adjacent to the proximal end of the mast in a manner such that the mast projects away from the object in a direction extending from the proximal end of the mast to the distal end of the mast at an angle toward the first support projection direction and the second support projection direction; and
wherein the mast includes a sleeve arranged along the length of the mast, the sleeve being adapted and configured to receive a further mast of a further flag.

2. The flag assembly of claim 1 wherein the proximal end of the mast comprises a hinge assembly, the hinge assembly includes a first portion that is adapted and configured for connection with the object, and a second portion that is hingedly connected to the first portion with the mast projecting from the second portion, the hinge assembly defines a pivot axis parallel to the first support projection direction and the second support projection direction.

3. The flag assembly of claim 2 wherein the first and second portions of the hinge assembly are releasably connected to each other.

4. The flag assembly of claim 2 wherein the first and second portions of the hinge assembly comprise plates defining planes parallel to the first support projection direction and the second support projection direction.

5. The flag assembly of claim 1 wherein the angle is between 60 degrees and 80 degrees.

6. The flag assembly of claim 1 wherein the flag element comprises one of (a) through openings having a pattern resembling a flag and (b) an applique on a rigid panel resembling a flag.

7. The flag assembly of claim 1 further comprising:
a third support projecting from the mast at a third support location, the third support location being intermediate of the proximal end of the mast and the second support location, the third support projects away from the mast in a third support projection direction, the third support projection direction being parallel to the first support projection direction and the second support projection direction; and
a further panel disposed between the second and third supports.

8. The flag assembly of claim 7 wherein the further panel comprises one of a flag and a nameplate.

9. The flag assembly of claim 1 wherein the distal end of the mast comprises at least one of a light, a camera, and an antenna.

10. The flag assembly of claim 1 wherein the flag element has a conventional top and a conventional bottom, the conventional top of the flag element is adjacent the first support.

11. A flag assembly comprising:
a mast having a proximal end and a distal end with a length extending between the proximal end and the distal end;
first and second supports, the first support projecting from the mast in a first support projection direction at a first support location along the length of mast, the second support projecting from the mast in a second support projection direction at a second support location along the length of mast, the first support location being closer to the proximal end of the mast along the length of the mast than the second support location, the first support projection direction and the second support projection direction being parallel to each other; and
a flag element disposed between the first and second supports, the flag element having a conventional top and a conventional bottom, the conventional top of the flag element being adjacent the first support;
wherein the mast is adapted and configured to be mounted to an object at or adjacent to the proximal end of the mast in a manner such that the mast projects in a direction away from the object from the proximal end of the mast to the distal end of the mast at an angle toward the first support projection direction and the second support projection direction.

12. The flag assembly of claim 11 wherein the second support location is adjacent to the distal end of the mast.

13. The flag assembly of claim 11 wherein the angle is between 60 degrees and 80 degrees.

14. The flag assembly of claim 11 wherein the flag element has one of (a) through openings having a pattern resembling a flag and (b) an applique on a rigid panel resembling a flag.

15. The flag assembly of claim 11 further comprising:
a third support projecting from the mast at a third support location in a third support direction, the third support location being intermediate of the distal end of the mast and the second support location, the third support projects from the mast in a third support projection direction, the third support projection direction being parallel to the first support and the second support; and
a further panel disposed between the second and third supports.

16. The flag assembly of claim 15 wherein the further panel comprises at least one of a flag and a nameplate.

17. The flag assembly of claim 11 wherein the distal end of the mast includes at least one of a light and a camera.

18. The flag assembly of claim 11 wherein the proximal end of the mast includes one of a plate adapted and configured for connection with the other object and a split ring assembly adapted and configured for connection with the other object.
